(19) United States
(12) Patent Application Publication
(10) Pub. No.: US 2013/0121681 A1
(43) Pub. Date: May 16, 2013

(54) CAMERA MODULE

(71) Applicant: Seung Seoup LEE, Suwon (KR)

(72) Inventor: Seung Seoup LEE, Suwon (KR)

(73) Assignee: SAMSUNG ELECTRO-MECHANICS CO., LTD., Suwon (KR)

(21) Appl. No.: 13/345,245

(22) Filed: Jan. 6, 2012

(30) Foreign Application Priority Data
Nov. 10, 2011 (KR) 10-2011-0116899

(51) Int. Cl. G03B 9/02

(52) U.S. Cl. 396/508

(57) ABSTRACT

There is provided a camera module including: a first diaphragm opened and closed according to a first electrical signal and including a first light quantity adjustment hole having a first size when being closed; a second diaphragm opened and closed according to a second electrical signal and including a second light quantity adjustment hole having a second size different from the first size when being closed; and a control unit electrically connected to the first and second diaphragms and controlling the first and second electrical signals transmitted to the first and second diaphragms, respectively.

### CROSS-REFERENCE TO RELATED APPLICATIONS

This application claims the priority of Korean Patent Application No. 10-2011-0116899 filed on Nov. 10, 2011, in the Korean Intellectual Property Office, the disclosure of which is incorporated herein by reference.

### BACKGROUND OF THE INVENTION

1. Field of the Invention

The present invention relates to a camera module, and more particularly, to a camera module capable of adjusting a quantity of light.

2. Description of the Related Art

A camera module has been mounted in a mobile terminal, including a mobile phone, according to the development of various related technologies and consumers demand.

At an initial stage, a camera module merely added an additional function to a mobile terminal, simply being able to capture an image of an object within a short distance. However, recently, as functions (e.g., a video call, or the like) connected to the main functions of mobile terminals have been diversified, camera module performance has been required to be enhanced.

Meanwhile, a general camera including a camera module includes a diaphragm (or aperture) for adjusting a quantity of light. The diaphragm is mechanically opened or closed according to an electrical signal to adjust a quantity of reflected light made incident to an image sensor of the camera, thereby enhancing the sharpness or resolution of images imaged by the camera module.

Thus, a mobile terminal camera module is required to have a diaphragm so as to improve the performance thereof.

However, since mobile terminals have tended to become compact, it is difficult to increase the size of the camera module so as to configure the diaphragm.

Thus, the development of a camera module capable of being mounted in a compact mobile terminal and having a diaphragm is urgently required.

### SUMMARY OF THE INVENTION

An aspect of the present invention provides a camera module capable of having a diaphragm and being mounted in a compact mobile terminal.

According to an aspect of the present invention, there is provided a camera module including: a first diaphragm opened and closed according to a first electrical signal and including a first light quantity adjustment hole having a first size when being closed; a second diaphragm opened and closed according to a second electrical signal and including a second light quantity adjustment hole having a second size different from the first size when being closed; and a control unit electrically connected, to the first and second diaphragms and controlling the first and second electrical signals transmitted to the first and second diaphragms, respectively.

Each of the diaphragms may include a transparent substrate; and a shielding member formed on the transparent substrate, disposed to have a circular shape based on a central point of the transparent substrate through which an optical axis passes, and including a fixed portion fixed to the transparent substrate and a movable portion folded or unfolded based on the fixed portion.

The transparent substrate may have a transparent electrode supplying a current to the shielding member.

The shielding member may be formed by disposing two members having residual stresses of different magnitudes in an overlapping manner.

The shielding member may be formed by disposing two members, one of which having tensile residual stress and the other of which having compressive residual stress, in an overlapping manner.

The shielding member may include a piezoelectrically-driven member.

The shielding member may include a plurality of creases formed to be perpendicular to a folding direction, so as to be easily folded.

The first and second diaphragms may be disposed on an object side of a lens unit.

The first and second diaphragms may be disposed between a lens unit and an image sensor unit.

The first diaphragm may be disposed on an object side of a lens unit and the second diaphragm may be disposed between the lens unit and an image sensor unit.

The first and second diaphragms may be disposed between lenses such that a focal length between the lenses is maintained.

The camera module may further include one or more third diaphragms including a third light quantity adjustment hole having a third size different from the first and second sizes when being closed.

The first light quantity adjustment hole or the second light quantity adjustment hole may have a size entirely blocking reflected light made incident to an image sensor unit.

The control unit may be electrically connected to an image sensor unit, output the first and second electrical signals to open both of the first and second diaphragms when a quantity of light made incident to the image sensor unit is less than a preset minimum quantity of light, and output the first and second electrical signals to selectively close the first diaphragm or the second diaphragm when the quantity of light made incident to the image sensor unit is greater than a preset maximum quantity of light.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a camera module according to a first embodiment of the present invention;

FIG. 2 is a perspective view showing the configuration of diaphragms illustrated in FIG. 1;

FIGS. 3 through 5 are cross-sectional views of the diaphragms illustrated in FIG. 2;

FIGS. 6 through 8 are perspective views showing operational states of the diaphragms illustrated in FIG. 2;

FIG. 9 is a cross-sectional view of a camera module according to a second embodiment of the present invention; and

FIG. 10 is a cross-sectional view of a camera module according to a third embodiment of the present invention.

### DETAILED DESCRIPTION OF THE PREFERRED EMBODIMENT

Hereinafter, embodiments of the present invention will be described in detail with reference to the accompanying drawings.

In describing the present invention below, terms indicating components of the present invention are named in consideration of the functions thereof. Therefore, the terms used herein should not be understood as limiting technical components of the present invention.

A camera module mounted in a mobile terminal includes a diaphragm (or stop). The diaphragm has a hole smaller than an effective face of a lens, whereby a quantity of light made incident to an image sensor is adjusted and unnecessary reflected light is prevented from being made incident to the image sensor.

However, the size of the hole of the diaphragm is fixed, so it may be difficult to adjust a quantity of light according to an image capturing environment. For example, when an image is captured in cloudy weather, a relatively large quantity of light is required, and when an image is captured on a sunny day (or in fine weather), a relatively small quantity of light is required, but the related art camera module is substantially unable to adjust a quantity of light through the diaphragm.

In order to solve this problem, the present invention provides a camera module capable of adjusting an area of the diaphragm to be opened or closed according to an image capturing environment.

In particular, the diaphragm of the camera module according to the embodiment of the present invention has a form of a thin film and the opening and closing of the diaphragm may be simplified, so that, the size of the camera module is not increased.

In addition, the camera module according to the embodiment of the present invention includes a plurality of diaphragms including light quantity adjustment holes having different sizes, so that a quantity of light can be adjusted in multiple stages.

Thus, according to an embodiment of the present invention, a compact camera module having high functionality can be fabricated, and accordingly, the functionality of a mobile terminal can be further enhanced.

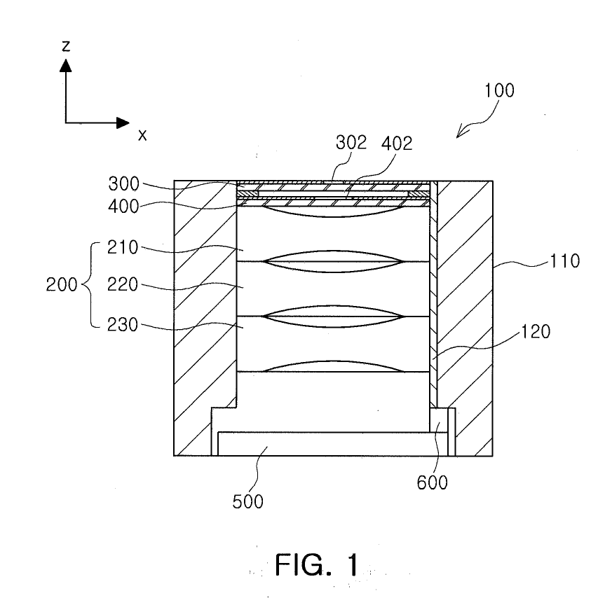

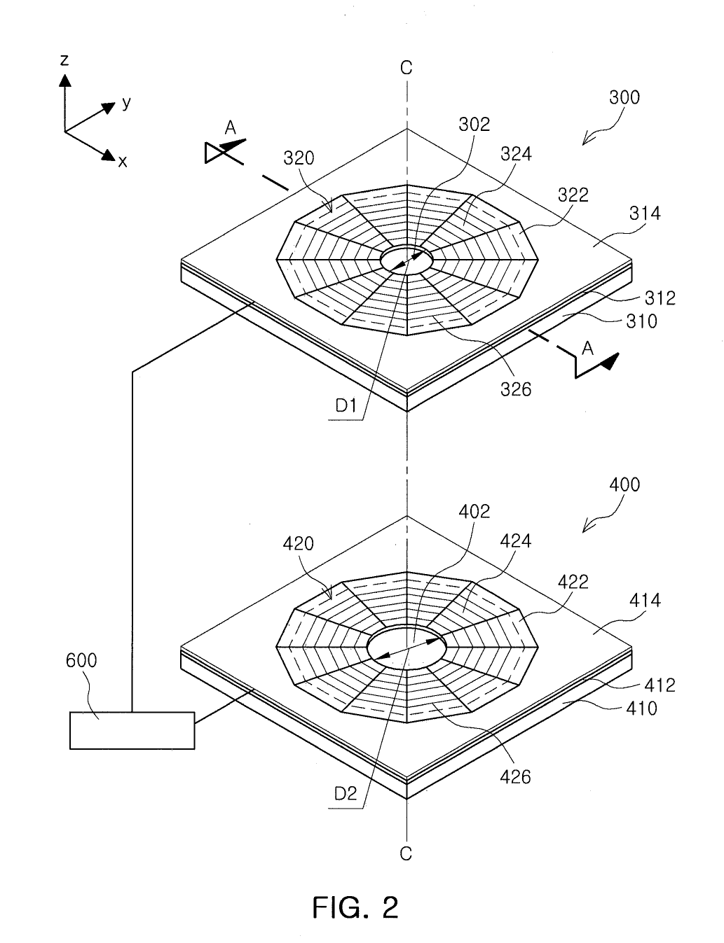

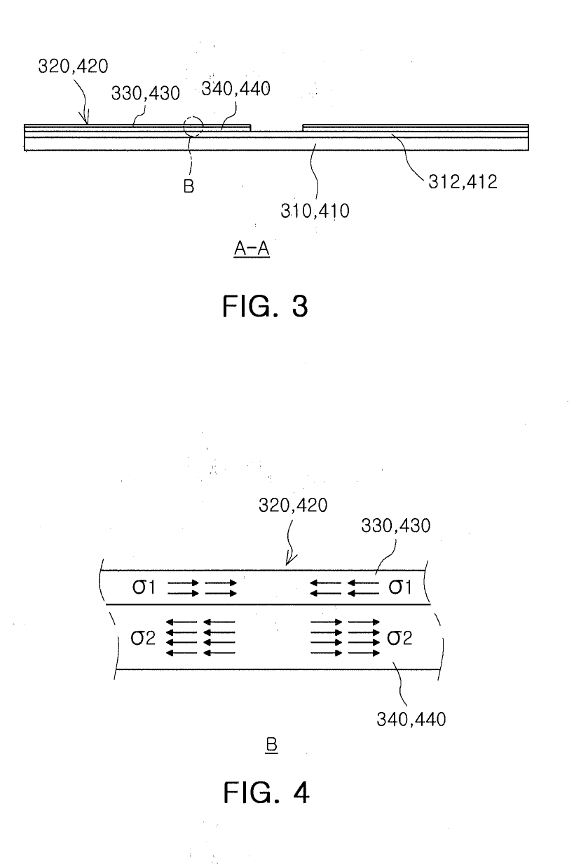

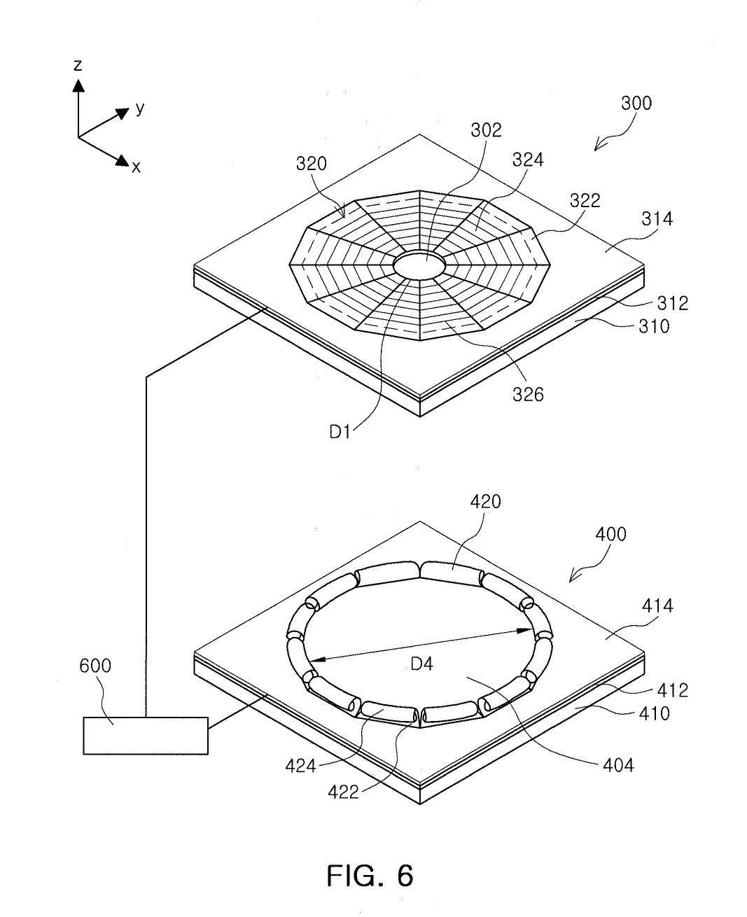

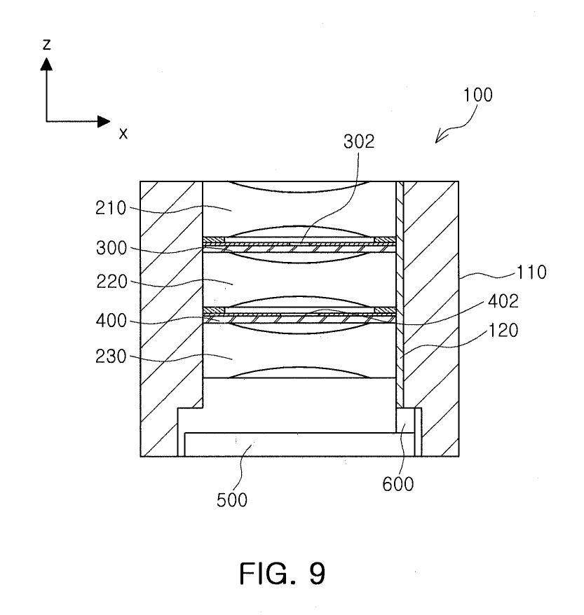

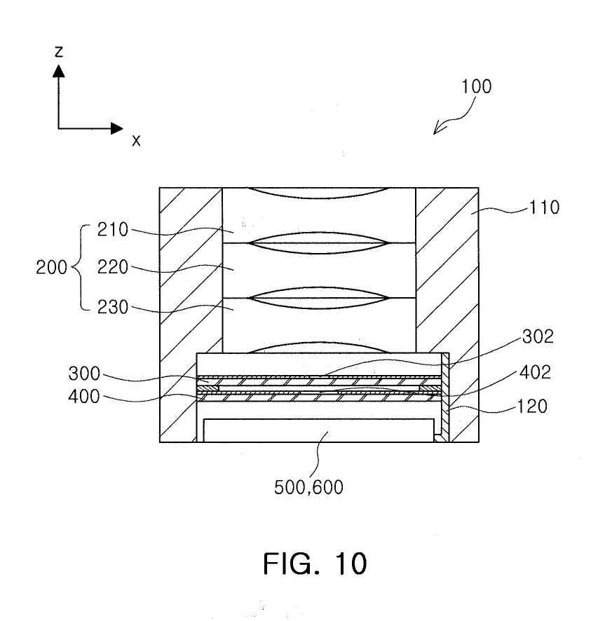

FIG. 1 is a cross-sectional view of a camera module according to a first embodiment of the present invention. FIG. 2 is a perspective view showing the configuration of diaphragms illustrated in FIG. 1. FIGS. 3 through 5 are cross-sectional views of the diaphragms illustrated in FIG. 2. FIGS. 6 through 8 are perspective views showing operational states of the diaphragms illustrated in FIG. 2. FIG. 9 is a cross-sectional view of a camera module according to a second embodiment of the present invention. FIG. 10 is a cross-sectional view of a camera module according to a third embodiment of the present invention.

A camera module according to a first embodiment of the present invention will be described with reference to FIGS. 1 through 8.

A camera module 100 according to the first embodiment of the present invention may include a housing 110, a lens unit 200, diaphragms 300 and 400, an image sensor unit 500, and a control unit 600.

The housing 110 may have a polyhedral shape with one opened face and may dictate an external appearance of the camera module 100. For example, the housing 110 may have a hexahedral shape having a quadrangular section and may include an accommodation space opened in a vertical direction (i.e., in a Z-axis direction based on FIG. 1).

The housing 110 may be fabricated by injection molding. To this end, the housing 110 may be formed of a resin or a metallic material appropriate for injection molding.

Meanwhile, in the accompanying drawings, it is illustrated that the camera module 100 includes the housing 110, but the housing 110 may be omitted according to a type of a mobile terminal in which the camera module 100 is mounted. In this case, the housing may be substituted with a case of the mobile terminal.

The housing 110 may include a metal pattern 120. The metal pattern 120 may be formed to extend along a heightwise direction (i.e., the Z-axis direction based on FIG. 1) of the housing 110 and electrically connect the diaphragms 300 and 400 to the control unit 600.

The metal pattern 120 may be integrally formed with the housing 110 through insert injection. However, the method of forming the metal pattern 120 is not limited thereto and may be modified within a range in which a person skilled in the art knows or recognizes.

The lens unit 200 may be installed in the housing 110. The lens unit 200 may include a plurality of lenses 210, 220, and 230, and may concentrate light reflected from an object through the lenses 210, 220, and 230 on the image sensor unit 600.

Here, a first lens 210, a second lens 220, and a third lens 230 may be disposed in parallel based on an optical axis and may have different refractive power and refractive index, respectively. For example, the first lens 210 and the second lens 220 may have positive refractive power and the third lens 230 may have negative refractive power.

The refractive index of the first lens 210 and the second lens 220 may be different from each other. To this end, the first lens 210 and the second lens 220 may be formed of different materials. For example, the first lens 210 may be formed of a glass material, and the second lens 220 may be formed of a plastic material.

In order to enhance chromatic aberration of the camera module, the first lens 210 and the second lens 220 may have different Abbe values. For example, the first lens 210 may have an Abbe value greater than or smaller than that of the second lens 220. When the Abbe values of the first lens 210 and the second lens 220 are different, chromatic aberration can be easily corrected.

In detail, a difference between the Abbe value of the first lens 210 and that of the second lens 220 may be 10 or greater, and may be selected from within the range of 10 to 40 as necessary.

Here, when the difference between the Abbe value of the first lens 210 and that of the second lens 220 is smaller than 10, the correction of chromatic aberration may be weak, and when the difference therebetween is greater than 40, unit fabrication costs may be greatly increased. Thus, the difference between the Abbe value of the first lens 210 and that of the second lens 220 may be maintained within the range of 10 to 40.

Meanwhile, the lens unit 200 according to the present embodiment includes the three lenses of the first lens 210, the second lens 220, and the third lens 230, but the number of lenses may be increased or decreased according to the purpose and function of the camera module 100. In addition, an interval maintaining member (not shown) for maintaining a focal length between the lenses 210, 220, and 230 may be further disposed among the lenses 210, 220, and 230. The size and installation of the interval maintaining member may vary according to optical characteristics desired to be achieved through the lenses 210, 220, and 230.

The diaphragms 300 and 400 may be disposed on the lens unit 200. However, the diaphragms 300 and 400 may be disposed in any position within an optical path connecting the lens unit 200 and the image sensor unit 500. For example, the diaphragms 300 and 400 may be disposed in front of or behind the lens unit 200 or may be disposed on the image sensor unit 500.

The diaphragms 300 and 400 may include a first diaphragm 300 and a second diaphragm 400. The first diaphragm 300 and the second diaphragm 400 may perform an opening and closing operation according to an electrical signal. For example, the first diaphragm 300 may be opened or closed according to a first electrical signal, and the second diaphragm 400 may be opened or closed according to a second electrical signal.

The first diaphragm 300 and the second diaphragm 400 may have light quantity adjustment holes 302 and 402 having different sizes. For example, a first light quantity adjustment hole 302 of the first diaphragm 300 may be smaller than a second light quantity adjustment hole 402 of the second diaphragm 400.

A detailed structure of the diaphragms 300 and 400 will be described with reference to FIG. 2.

The diaphragms 300 and 400 may include transparent substrates 310 and 410 and shielding members 320, and 420, respectively.

The transparent substrates 310 and 410 may dictate an external appearance of the diaphragms 300 and 400 and may be formed of a mixed material including glass, quartz, plastic, or silica allowing light to be transmitted therethrough.

Transparent electrodes 312 and 412 and light blocking members 314 and 414 may be formed on the transparent substrates 310 and 410, respectively.

The transparent electrodes 312 and 412 may be formed on the entirety of one surface (i.e., an upper surface based on FIG. 2) of the respective transparent substrates 310 and 410. The transparent electrodes 312 and 412 may be formed through thin film deposition on the transparent substrate 310 and 410, and may be formed of a material such as indium tin oxide (ITO), ZnO, SnO₂, CNT, conductive polymer, or the like. The transparent electrodes 312 and 412 may be connected to the control unit 600 through the metal pattern 120.

The light blocking members 314 and 414 may be formed on the transparent electrodes 312 and 412, respectively. In detail, the light blocking members 314 and 414 may be formed on portions, excluding the portions on which the shielding members 320 and 420 are to be formed, of the transparent electrodes 312 and 412. The light blocking members 314 and 414 may be formed of a mixed material including chromium (Cr), or may include a black material that can shield light.

The shielding members 320 and 420 may be formed on the transparent substrates 310 and 410. In detail, the shielding members 320 and 420 may be formed on the transparent electrodes 312 and 412, respectively.

The shielding members 320 and 420 may have a trapezoid shape and may be disposed in a circular shape based on an optical axis (based on a segment C-C). The plurality of shielding members 320 and 420 may have an equilateral polygonal shape, and may have the light quantity adjustment holes 302 and 402 formed at the central portion through which the optical axis passes. Here, a size D1 of the first light quantity adjustment hole 302 formed by the first shielding member 320 may be different from a size D2 of the second light quantity adjustment hole 402 formed by the second shielding member 420. For reference, in the present embodiment, the first light quantity adjustment hole 302 may be smaller than the second light quantity adjustment hole 402. However, this is merely an illustrative example, and the first light quantity adjustment hole 302 may be greater than the second light quantity adjustment hole 402 as necessary.

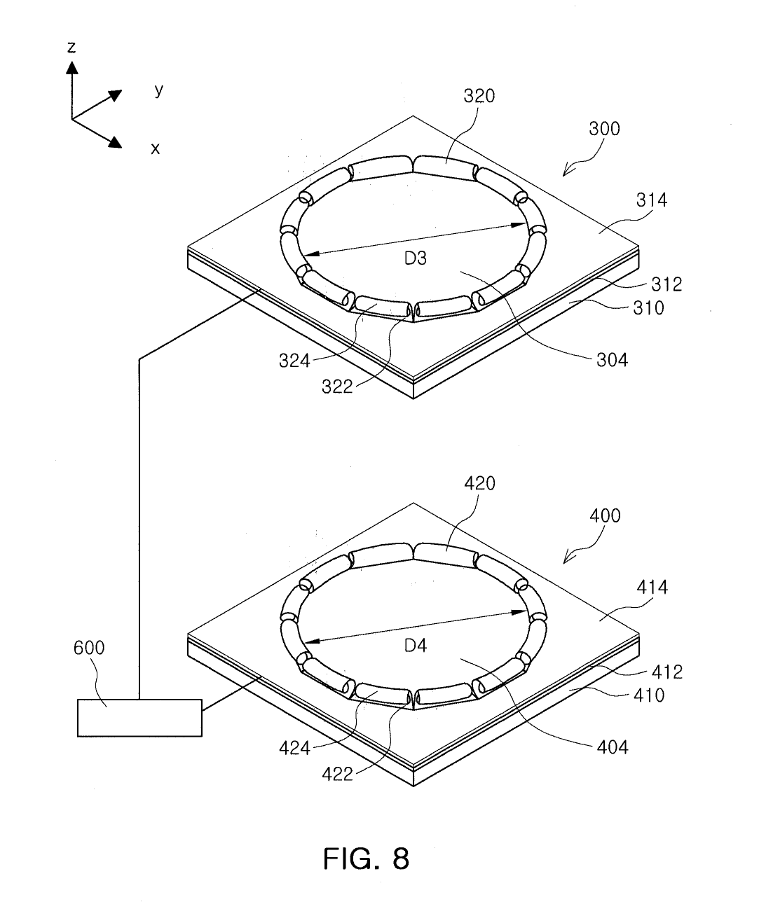

Meanwhile, when the shielding members 320 and 420 are completely opened as shown in FIG. 8, light quantity adjustment holes 304 and 404 may have sizes D3 and D4 allowing all light made incident through the lens unit 200 to be transmitted therethrough. Here, the size D3 of the light quantity adjustment hole 304 and the size D4 of the light quantity adjustment hole 404 may be equal or different.

The shielding members 320 and 420 may include fixed portions 322 and 422 fixed to the transparent substrates 310 and 410 and movable portions 324 and 424 that can be opened and closed with respect to the transparent substrates 310 and 410. Namely, in the shielding members 320 and 420, the movable portions 324 and 424 may be folded or unfolded, based on the fixed portions 322 and 422 so as to selectively open and close the transparent substrates 310 and 410, respectively. Here, the operation of the movable portions 324 and 424 may be performed by an electrical signal from the control unit 600. The movable portions 324 and 424 may include a plurality of creases formed to be perpendicular to a folding direction, so as to be easily folded.

To this end, as shown in FIGS. 3 through 5, the shielding members 320 and 420 may include a plurality of members. For example, the shielding members 320 and 420 may include first members 330 and 430 and second members 340 and 440, respectively. The first members 330 and 430 and the second members 340 and 440 may be formed of the same material and may be coupled by an adhesive.

The first members 330 and 430 and the second members 340 and 440 may be operated by an electrical signal or a current. For example, the first members 330 and 340 and the second members 340 and 440 may be formed of a shape memory alloy. In this case, the shapes of the first members 330 and 430 and the second members 340 and 440 may be changed according to whether or not a current is supplied thereto. For example, the first members 330 and 340 are alloys memorized to be folded when a current is received, and the second members 340 and 440 may be alloys memorized to be unfolded when a current is not received.

In another example, as shown in FIG. 4, the first members 330 and 430 and the second members 340 and 440 may have different residual stresses. For example, the first members 330 and 430 may have first residual stress σ1 and the second members 340 and 440 may have second residual stress σ2. Here, the first residual stress σ1 and the second residual stress σ2 may have different magnitudes, or the first residual stress σ1 and the second residual stress σ2 may have different directions. For example, the first residual stress σ1 may be tensile residual stress and the second residual stress σ2 may be compressive residual stress. In addition, the first residual stress σ1 and the second residual stress σ2 may be activated according to the supply of current.

The first members 330 and 430 and the second members 340 and 440 configured in this manner may be folded or unfolded according to a difference between magnitudes or directions of the residual stresses.

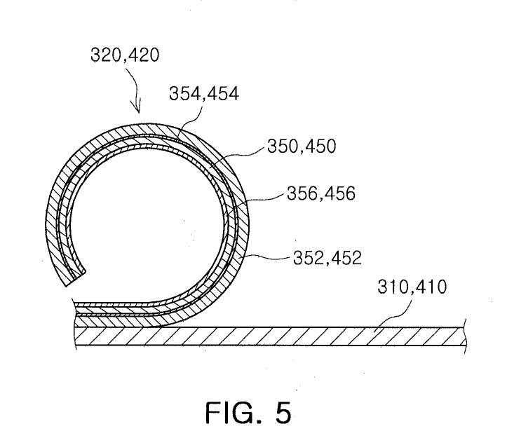

In another example, as shown in FIG. 5, the shielding members 320 and 420 may include piezoelectrically-driven members 350 and 450 expanded and contracted by a current. Here, the shielding members 320 and 420 may include first electrodes 354 and 454 and second electrodes 356 and 456 for operating the piezoelectrically-driven members 350 and 450, and further include insulating members 352 and 452.

The diaphragms 300 and 400 may be selectively opened and closed according to an electrical signal as described above.

For example, as shown in FIG. 6, the first diaphragm 300 may be changed to be closed and the second diaphragm 400 may be changed to be opened. In this case, since light is transmitted only through the first light quantity adjustment hole 302 of the first diaphragm 300, a relatively small quantity of light may be made incident to the image sensor unit 500. Thus, this setting may be appropriately used in sunny conditions in which high levels of solar radiation are present.

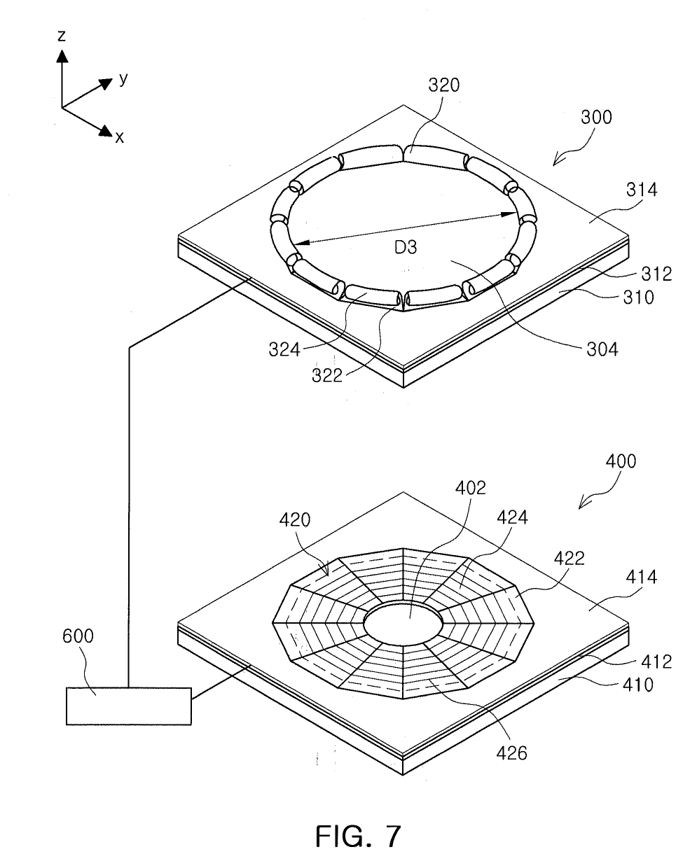

In another example, as shown in FIG. 7, the first diaphragm 300 may be changed to be opened and the second diaphragm 400 may be changed to be closed. In this case, since light is transmitted only through the second light quantity adjustment hole 402 of the second diaphragm 400, a relatively large quantity of light may be made incident to the image sensor unit 500, compared with the case of FIG. 6. Thus, this setting may be appropriately used in overcast conditions in which a relatively small quantity of light is present.

In another example, as shown In FIG. 8, both the first diaphragm 300 and the second diaphragm 400 may be changed to be opened. In this case, a large quantity of light can be made incident to the image sensor unit 500. Thus, this setting can be appropriately used during the night or in indoors when an insufficient quantity of light is present.

Meanwhile, in this embodiment, the camera module 100 includes two diaphragms 300 and 400, but the camera module 100 may further include a third diaphragm having a third light quantity adjustment hole having a size different from those of the first light quantity adjustment hole 302 and the second light quantity adjustment hole 402 as necessary.

The image sensor unit 500 may be disposed in a lower portion (the direction is based on FIG. 1) of the housing 110. The image sensor unit 500 may convert an image of an object into an electrical signal through light made incident through the lens unit 200.

The image sensor unit 500 may have a form of a chip scale package (CSP) to reduce the size of the camera module 100 and may include a connection terminal to be electrically connected to a circuit board of a mobile terminal.

In order to cancel noise by infrared rays, the image sensor unit 500 may include an IR filter or a cover glass. The IR filter may be omitted. The IR filter may be integrally formed with the image sensor unit 500 or may be formed by a coating method or the like, according to circumstances.

The control unit 600 may be disposed within or outside the housing 110. Alternatively, the control unit 600 may be formed on the image sensor unit 500 or may be integrally formed with the image sensor unit 500. Alternatively, the control unit 600 may be formed on the substrate of the mobile terminal. In either case, the control unit 600 may adjust the opening and closing state of the diaphragms 300 and 400 through a signal input by a user or a separate signal.

For example, in a fine weather (i.e., when the quantity of light is greater than a reference previously set in the control unit 600), the control unit 600 may control the diaphragms 300 and 400 to have the setting illustrated in FIG. 6, and in a cloudy weather or at night (i.e., when the quantity of light is less than a reference previously set in the control unit 600), the control unit 600 may control the diaphragms 300 and 400 to have the setting illustrated in FIG. 8.

Meanwhile, although not shown, the camera module 100 may include an optical sensor for sensing brightness of a surrounding environment. In this case, the control unit 600 may control the opening and closing operation of the diaphragms 300 and 400 based on information received from the optical sensor.

In this manner, according to the present embodiment, since the diaphragms 300 and 400 of the camera module 100 can be changed into various states, image capturing appropriate for surrounding environments may be performed, and accordingly, high resolution image data may be obtained.

Camera modules according to second and third embodiments of the present invention will be described with reference to FIGS. 9 and 10.

In the camera module 100 according to the second embedment of the present invention, the first diaphragm 300 and the second diaphragm 400 may be disposed between any two of the lenses 210, 220, and 230.

In general, a certain focal length is required among the lenses 210, 220, and 230, so a space maintaining member may be required. This is considered in the present embodiment such that the diaphragms 300 and 400 are disposed between the lenses, thus omitting a space maintaining member and blocking reflected light generated between lens faces.

Thus, the resolution of the camera module 100 according to the present embodiment may be further enhanced.

In the camera module 100 according to the third embodiment of the present invention, the first diaphragm 300 and the second diaphragm 400 may be disposed above the image sensor unit 500. In general, there is extra space between the lens unit 200 and the image sensor unit 500, so the diaphragms 300 and 400 may be disposed in the corresponding space.

In the present embodiment, since the distance between the diaphragms 300 and 400 and the image sensor unit 500 is short, the control unit 600 may be integrally formed with the image sensor unit 500, and the diaphragms 300 and 400 and the image sensor unit 500 may be electrically connected. Here, electrical connection between the diaphragms 300 and 400 and the image sensor unit 500 may include wire bonding.

As set forth above, according to embodiments of the invention, since the size of the camera module is not increased, the camera module can be mounted in a compact mobile terminal.

In addition, since a quantity of light made incident to the image sensor through the plurality of diaphragms is selectively adjusted, the performance of the camera module can be enhanced.

While the present invention has been shown and described in connection with the embodiments, it will be apparent to those skilled in the art that modifications and variations can be made without departing from the spirit and scope of the invention as defined by the appended claims.

What is claimed is:

1. A camera module comprising:
a first diaphragm opened and closed according to a first electrical signal and including a first light quantity adjustment hole having, a first size when being closed;
a second diaphragm opened and closed according to a second electrical signal and including a second light quantity adjustment hole having a second size different from the first size when being closed; and
a control unit electrically connected to the first and second diaphragms and controlling the first and second electrical signals transmitted to the first and second diaphragms, respectively.

2. The camera module of claim 1, wherein each of the diaphragms includes:
a transparent substrate; and
a shielding member formed on the transparent substrate, disposed to have a circular shape based on a central point of the transparent substrate through which an optical axis passes, and including a fixed portion fixed to the transparent substrate and a movable portion folded or unfolded based on the fixed portion.

3. The camera module of claim 2, wherein the transparent substrate has a transparent electrode supplying a current to the shielding member.

4. The camera module of claim 2, wherein the shielding member is formed by disposing two members having residual stresses of different magnitudes in an overlapping manner.

5. The camera module of claim 2, wherein the shielding member is formed by disposing two members, one of which having tensile residual stress and the other of which having compressive residual stress, in an overlapping manner.

6. The camera module of claim 2, wherein the shielding member includes a piezoelectrically-driven member.

7. The camera module of claim 2, wherein the shielding member includes a plurality of creases formed to be perpendicular to a folding direction, so as to be easily folded.

8. The camera module of claim 1, wherein the first and second diaphragms are disposed on an object side of a lens unit.

9. The camera module of claim 1, wherein the first and second diaphragms are disposed between a lens unit and an image sensor unit.

10. The camera module of claim 1, wherein the first diaphragm is disposed on an object side of a lens unit and the second diaphragm is disposed between the lens unit and an image sensor unit.

11. The camera module of claim 1, wherein the first and second diaphragms are disposed between lenses such that a focal length between the lenses is maintained.

12. The camera module of claim 1, further comprising one or more third diaphragms including a third light quantity adjustment hole having a third size different from the first and second sizes when being closed.

13. The camera module of claim 1, wherein the first light quantity adjustment hole or the second light quantity adjustment hole has a size entirely blocking reflected light made incident to an image sensor unit.

14. The camera module of claim 1, wherein the control unit is electrically connected to an image sensor unit, outputs the first and second electrical signals to open both of the first and second diaphragms when a quantity of light made incident to the image sensor unit is less than a preset minimum quantity of light, and outputs the first and second electrical signals to selectively close the first diaphragm or the second diaphragm when the quantity of light made incident to the image sensor unit is greater than a preset maximum quantity of light.
